(19) United States
(12) Patent Application Publication
(10) Pub. No.: US 2020/0398784 A1
(43) Pub. Date: Dec. 24, 2020

(54) HOUSING FOR SEATBELT PRETENSIONER

(71) Applicant: ZF Passive Safety Systems US Inc, Washington, MI (US)

(72) Inventor: Daniel R. Sutherland, Richmond Township, MI (US)

(21) Appl. No.: 16/447,998

(22) Filed: Jun. 21, 2019

(51) Int. Cl. B60R 22/24; B60R 22/02; B60R 22/46

(52) U.S. Cl. CPC B60R 22/24; B60R 2022/1825; B60R 22/4628; B60R 22/023

(57) ABSTRACT

A pretensioner housing of a seatbelt system pretensioner and a method of forming the pretensioner housing. The pretensioner housing includes a sheet metal blank that is folded multiple times to form the pretensioner housing. The sheet metal blank has an integral mount for mounting a gas generator.

### FIELD OF THE INVENTION

The present invention relates to vehicle safety systems and, in particular, to a pretensioner housing of a seatbelt system.

### BACKGROUND TO THE INVENTION

Seatbelt systems are provided for restraining an occupant of a vehicle in the event of a collision. A typical 3-point seat belt arrangement 100 (FIG. 1) includes a lap belt section 105 that is configured to extend across the occupant's pelvis and a shoulder belt section 110 that is configured to cross the occupant's upper torso. The lap belt section 105 and the shoulder belt section 110 are formed by a continuous length of webbing 115. A belt retractor 120 is provided to store the webbing 115. A latch plate 125 attached to the webbing 115 is received by a buckle 130 to allow the belt arrangement 100 to be fastened for enabling restraint and unfastened to allow entrance and egress from the vehicle.

Seatbelt systems can be provided with a pretensioner that is configured to tension the seatbelt during an impact of the vehicle (or even prior to impact) to enhance occupant restraint performance. The pretensioner takes out slack in the webbing to cause the webbing to couple with an occupant earlier in a crash sequence. Various designs of retractor pretensioners presently exist, including a type that incorporates a gas generator for generating a pyrotechnic charge. Generally, ignition of the pyrotechnic charge creates gas pressure that imparts motion upon a driving element (e.g., rack). This motion of the driving element causes rotation of a driven element (e.g., pinion) that is attached to a spool of the belt retractor. Rotation of the driven element causes likewise rotation of the spool, thereby causing the webbing to be wound onto the spool and consequently taking out slack in the webbing.

The housing that accommodates the gas generator and the driving element can be costly and time consuming to manufacture. Therefore, it is desired to provide a housing that reduces cost and manufacturing time.

### SUMMARY OF THE INVENTION

According to one aspect of the invention, a seatbelt system includes a retractor frame. A spool is rotatably supported by the retractor frame. Webbing is stored on the spool. The seat belt system further includes a pretensioner. The pretensioner includes a pretensioner housing attached to the retractor frame. The pretensioner housing is formed from a sheet metal blank. The sheet metal blank has an integral mount for mounting a gas generator. The pretensioner housing has a plurality of walls that are separated by respective folding edges along which the sheet metal blank is folded to define an enclosed space.

According to another aspect of the invention, a method of forming a pretensioner housing of a seatbelt system pretensioner includes forming an open ended tube by folding a sheet metal blank. The sheet metal blank has an integral mount for mounting a gas generator. A first end of the tube is closed with a first end wall portion by folding the sheet metal blank along a first folding edge. A second end of the tube is closed with a second end wall portion by folding the sheet metal blank along a second folding edge.

### BRIEF DESCRIPTION OF THE DRAWINGS

Embodiments of the invention will now be described by way of example only, with reference to the accompanying drawings, in which:

FIG. 1 is an exemplary 3-point seatbelt arrangement;

FIG. 2 is a partially exploded view of a pretensioner;

FIG. 3 is a sectional view of the assembled pretensioner of FIG. 2;

FIG. 4 is a plan view of a sheet metal blank for forming a pretensioner housing according to one aspect of the invention;

FIG. 5 is perspective view of a pretensioner housing made from the sheet metal blank of FIG. 4;

FIG. 6 is another perspective view of the pretensioner housing of FIG. 5;

FIG. 7 is a plan view of a sheet metal blank for forming a pretensioner housing according to another aspect of the invention;

FIG. 8 is perspective view of a pretensioner housing made from the sheet metal blank of FIG. 7;

FIG. 9 is another perspective view of the pretensioner housing of FIG. 8;

FIG. 10 is a plan view of a sheet metal blank for forming a pretensioner housing according to another aspect of the invention;

FIG. 11 is perspective view of a pretensioner housing made from the sheet metal blank of FIG. 10;

FIG. 12 is another perspective view of the pretensioner housing of FIG. 11;

FIG. 13 is a plan view of a sheet metal blank for forming a pretensioner housing according to another aspect of the invention;

FIG. 14 is perspective view of a pretensioner housing made from the sheet metal blank of FIG. 13; and

FIG. 15 is another perspective view of the pretensioner housing of FIG. 14.

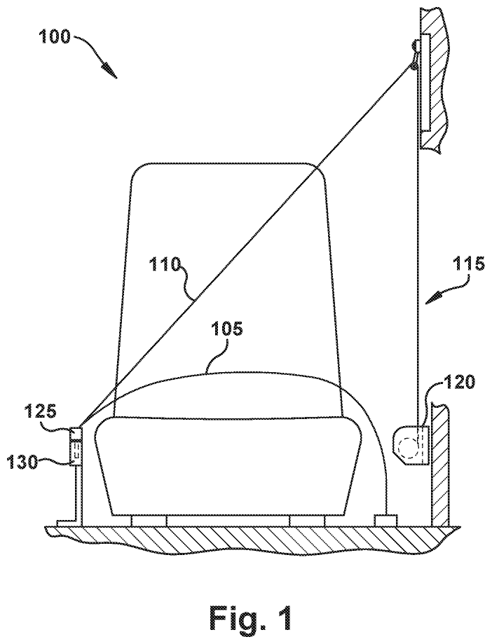

### DETAILED DESCRIPTION

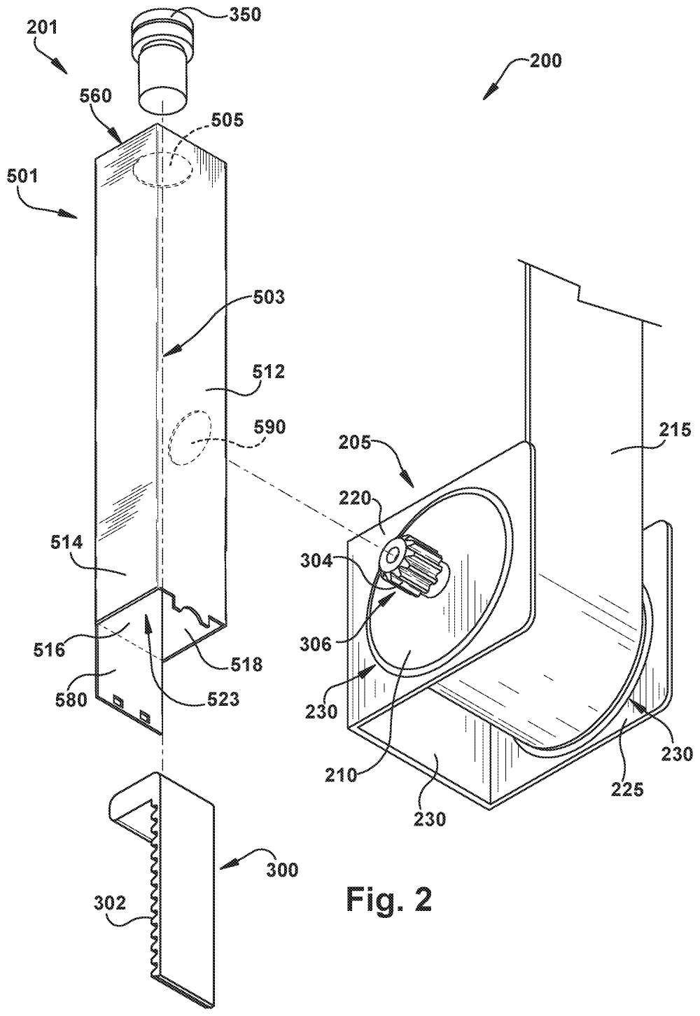

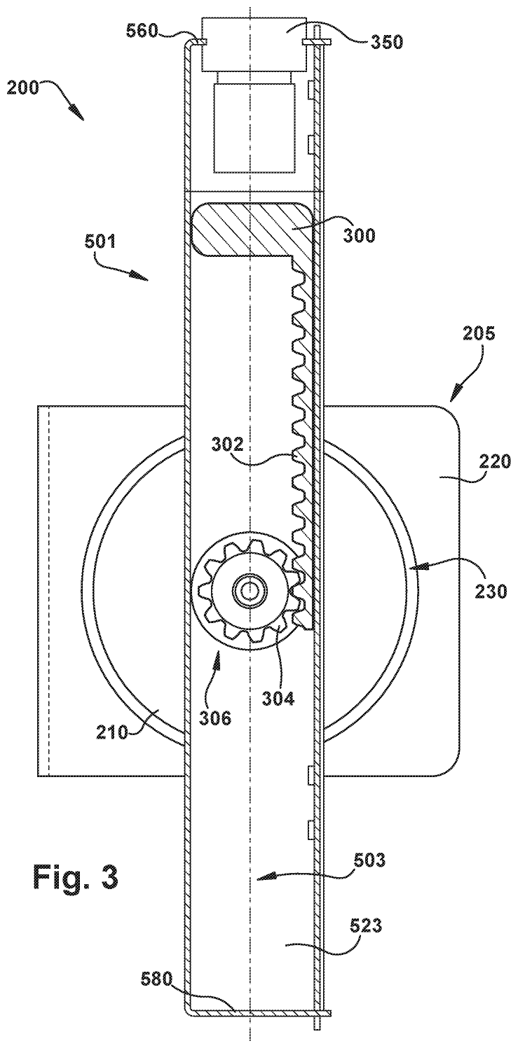

Part of a seatbelt system 200 is shown in FIGS. 2 and 3. The seatbelt system 200 includes a retractor frame 205 that rotatably supports a spool 210. Webbing 215 is stored on the spool. The retractor frame 205 includes a first side wall 220 and a second sidewall 225 that are spaced apart and connected by a rear wall 230. The first side wall 220 and the second sidewall 225 each include an aperture 230 for receiving the spool 210.

The seatbelt system 200 is provided with a pretensioner 201. The pretensioner includes a pretensioner housing 501 attached to the first sidewall 220. The pretensioner housing 501 extends along a longitudinal axis 503 from a first end wall portion 560 to a second end wall portion 580. A first sidewall portion 512, a second sidewall portion 514, a third sidewall portion 516, and a fourth sidewall portion 518 extend between the first end wall portion 560 and the second end wall portion 580. The first end wall portion 560, the second end wall portion 580, the first sidewall portion 512, the second sidewall portion 514, the third sidewall portion 516, and the fourth sidewall portion 518 define an enclosed space 523.

A rack 300 is received in the enclosed space 523. The rack 300 has teeth 302 that engage with teeth 304 of a pinion 306. The pinion 306 is connected for rotation with the spool 210. A gas generator 350 is received in an aperture 505 provided in the first end wall portion 560 of the pretensioner housing 501. The gas generator 350 is in fluid communication with the enclosed space 523 of the pretensioner housing 501. The gas generator 350 is actuatable to generate a pyrotechnic charge that moves the rack 300 relative to the pretensioner housing 501 along the longitudinal axis 503. This movement of the rack 300 forces the pinion 306, and thus the spool 210, to rotate. Rotation of the spool 210 causes the webbing 215 to be wound onto the spool 210, thereby removing slack from the webbing 215. The second end wall portion 580 acts as a stop and prevents the rack 300 from exiting the enclosed space 523 of the pretensioner housing 501.

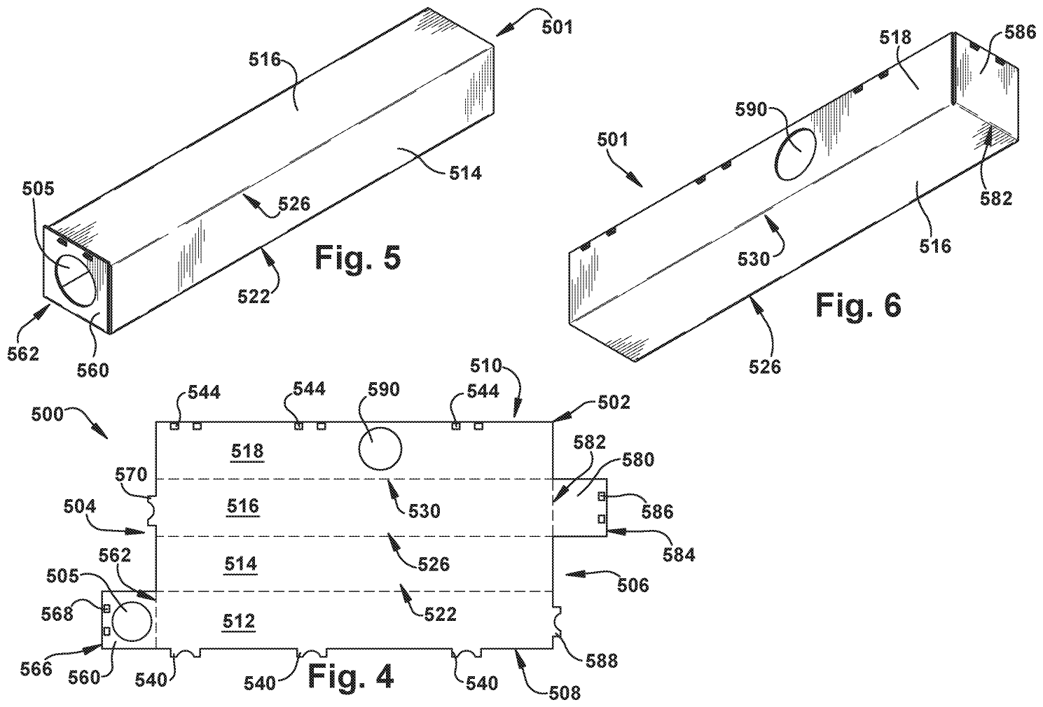

FIG. 4 shows one example of a sheet metal blank 500 for forming the pretensioner housing 501. The sheet metal blank 500 includes a main portion 502 having opposing first and second ends 504, 506 and opposing first and second sides 508, 510. The first sidewall portion 512, the second sidewall portion 514, the third sidewall portion 516, and the fourth sidewall portion 518 extend between the first end 504 and the second end 506. The second sidewall portion 514 shares a first folding edge 522 with the first sidewall portion 512. The second sidewall portion 514 spaces the third sidewall portion 516 from the first sidewall portion 512. The third sidewall portion 516 shares a second folding edge 526 with the second sidewall portion 514. The third sidewall portion 516 spaces the fourth sidewall portion 518 from the second sidewall portion 514. The fourth sidewall portion 518 shares a third folding edge 530 with the third sidewall portion 516. The fourth sidewall portion 518 includes an aperture 590 that is adapted to receive the pinion 306.

A plurality of first tabs 540 extend from the first sidewall portion 512 at the first side 508 of the main portion 502. A plurality of first slots 544 are provided in the fourth sidewall portion 518 adjacent the second side 510 of the main portion 502. The plurality of first slots 544 correspond to the plurality of first tabs 540.

The first end wall portion 560 extends from the first sidewall portion 512 at the first end 504 of the main portion 502. The first end wall portion 560 shares a fourth folding edge 562 with the first side wall portion 512. The first end wall portion 560 includes an integral mount for mounting the gas generator 350. In one example, the integral mount is the aperture 505 that receives the gas generator 350. The first end wall portion 560 includes a free edge 566 opposite the fourth folding edge 562. Second slots 568 are provided in the first end wall portion 560 adjacent the free edge 566. Second tabs 570 extend from the third sidewall portion 516 at the first end 504 of the main portion 502. The second tabs 570 correspond to the second slots 568.

The second end wall portion 580 extends from the third sidewall portion 516 at the second end 506 of the main portion 502. The second end wall portion 580 shares a fifth folding edge 582 with the third sidewall portion 516. The second end wall portion 580 includes a free edge 584 opposite the fifth folding edge 582. Third slots 586 are provided in the second end wall portion 580 adjacent the free edge 584. Third tabs 588 extend from the first sidewall portion 512 at the second end 506 of the main portion 502. The third tabs 588 correspond to the third slots 586.

An example method of manufacturing the pretensioner housing 501 (FIGS. 5 and 6) using the sheet metal blank 500 of FIG. 4 will now be described. First, the sheet metal blank 500 is folded along the first folding edge 522, the second folding edge 526, and the third folding edge 530. This causes the first side wall portion 512, the second side wall portion 514, the third side wall portion 516, and the fourth side wall portion 518 to form an open ended tube and brings the first tabs 540 into engagement with the first slots 544. The first tabs 541 are then secured in the first slots 544 by, for example, staking and/or welding.

Next, the sheet metal blank 500 is folded along the fourth folding edge 562. This causes the first end wall portion 560 to close the first open end of the tube formed by the sidewall portions 512, 514, 516, 518 and brings the second tabs 570 into engagement with the second slots 568. The second tabs 570 are then secured in the second slots 568. Next, the sheet metal blank is folded along the fifth folding edge 582. This closes the second open end of the tube formed by the sidewall portions 512, 514, 516, 518 and brings the third tabs 588 into engagement with the third slots 586. The third tabs 588 are then secured in the third slots 586, thereby completing the method of manufacturing the pretensioner housing 501. The completed pretensioner housing 501 can be attached to a retractor frame with the fourth sidewall portion 518 engaging the first sidewall 220 of the retractor frame 205 such that the pinion 306 extends through the aperture 590 in the fourth sidewall portion 518.

The foregoing method is provided only as an example. It is contemplated that the order of the disclosed folding and securing steps can be rearranged. Furthermore, it is contemplated that portions of the completed pretensioner housing 501 can be welded so as to seal the pretensioner housing 501. Additionally, as would be appreciated by one of ordinary skill in the art, the rack 300 can be inserted into the pretensioner housing 501 prior to any one of the steps described above, after the steps described above, or in-between the steps described above. Furthermore, as would be appreciated by one having ordinary skill in the art, the gas generator 350 can be attached to the pretensioner housing 501 prior to any one of the steps described above, after the steps described above, or in-between the steps described above.

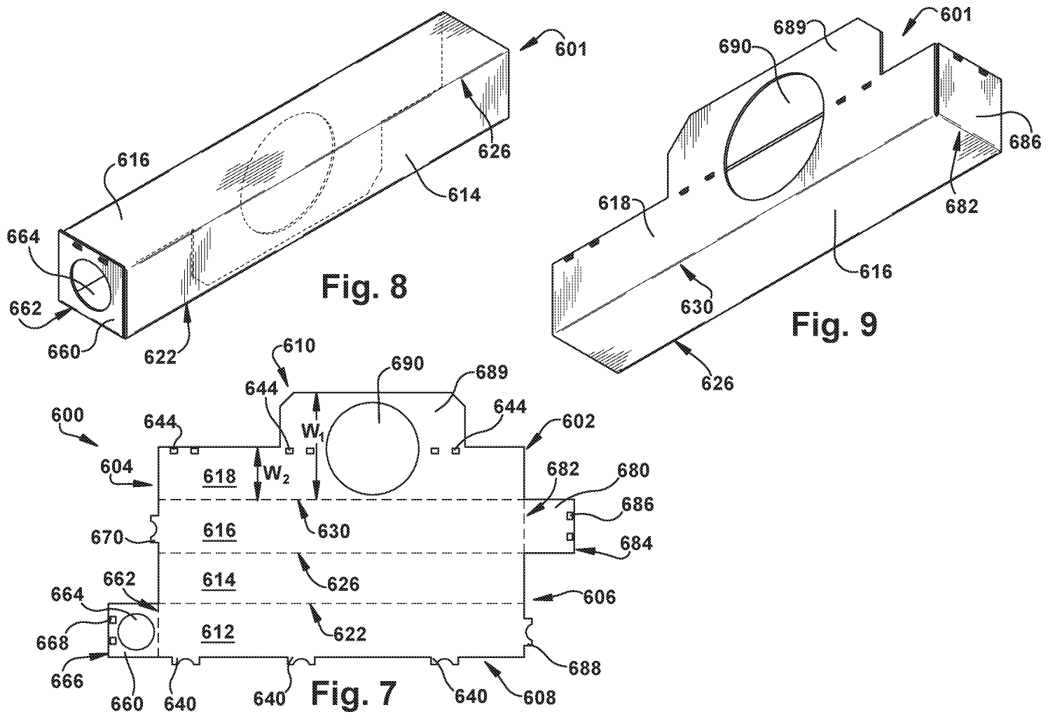

FIG. 7 shows another example of a sheet metal blank 600 for forming a pretensioner housing 601 (FIGS. 8 and 9). The sheet metal blank 600 includes a main portion 602 having opposing first and second ends 604, 606 and opposing first and second sides 608, 610. A first sidewall portion 612, a second sidewall portion 614, a third sidewall portion 616, and a fourth sidewall portion 618 extend between the first end 604 and the second end 606. The second sidewall portion 614 shares a first folding edge 622 with the first sidewall portion 612. The second sidewall portion 614 spaces the third sidewall portion 616 from the first sidewall portion 612. The third sidewall portion 616 shares a second folding edge 626 with the second sidewall portion 614. The third sidewall portion 616 spaces the fourth sidewall portion 618 from the second sidewall portion 614. The fourth sidewall portion 618 shares a third folding edge 630 with the third sidewall portion 616.

The fourth sidewall portion 618 includes a retractor frame section 689. The retractor frame section 689 is adapted to form a sidewall of the retractor frame to which the completed pretensioner housing is attached. The retractor frame section 689 has a width W₁ that is greater than a width W₂ of the remainder of the fourth sidewall portion 618. The retractor frame section 689 includes an aperture 690 that is adapted to receive a retractor spool.

A plurality of first tabs 640 extend from the first sidewall portion 612 at the first side 608 of the main portion 602. A plurality of first slots 644 are provided in the fourth sidewall portion 618 adjacent the second side 610 of the main portion 602 and on opposite sides of the aperture 690 of the retractor frame section 689. The plurality of first slots 644 correspond to the plurality of first tabs 640.

A first end wall portion 660 extends from the first sidewall portion 612 at the first end 604 of the main portion 602. The first end wall portion 660 shares a fourth folding edge 662 with the first sidewall portion 612. The first end wall portion 660 includes an integral mount for mounting a gas generator. In one example, the integral mount is an aperture 664 that is adapted to receive a gas generator. The first end wall portion 660 includes a free edge 666 opposite the fourth folding edge 662. Second slots 668 are provided in the first end wall portion 660 adjacent the free edge 666. Second tabs 670 extend from the third sidewall portion 616 at the first end 604 of the main portion 602. The second tabs 670 correspond to the second slots 668.

A second end wall portion 680 extends from the third sidewall portion 630 at the second end 606 of the main portion 602. The second end wall portion 680 shares a fifth folding edge 682 with the third sidewall portion 616. The second end wall portion 680 includes a free edge 684 opposite the fifth folding edge 682. Third slots 686 are provided in the second end wall portion 680 adjacent the free edge 684. Third tabs 688 extend from the first sidewall portion 612 at the second end 606 of the main portion 602. The third tabs 688 correspond to the third slots 686.

The method of manufacturing the pretensioner housing 601 using the sheet metal blank of FIG. 7 is substantially the same as the method described above in regard to the sheet metal blank of FIG. 4. The completed pretensioner housing 601 can then be attached to the partial retractor frame to form the first sidewall.

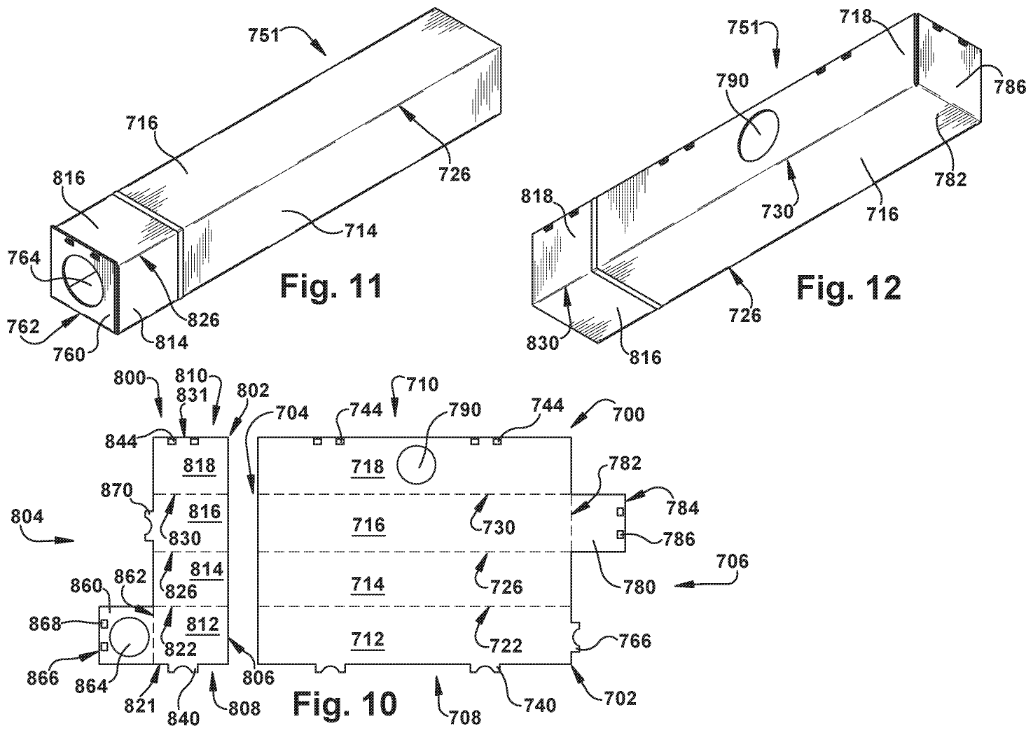

FIG. 10 shows another sheet metal blank 750 for forming a pretensioner housing 751 (FIGS. 11 and 12). The sheet metal blank 750 includes a rack housing part 700 and a gas generator housing part 800. The gas generator housing part 800 includes a gas generator main portion 802 having opposed first and second ends 804, 806 and opposing first and second sides 808, 810. A gas generator first sidewall portion 812, a gas generator second sidewall portion 814, a gas generator third sidewall portion 816, and a gas generator fourth sidewall portion 816 extend between the first end 804 and the second end 806. The gas generator second sidewall portion 814 shares a gas generator first folding edge 822 with the gas generator first sidewall portion 812. The gas generator second sidewall portion 814 spaces the gas generator third sidewall portion 816 from the gas generator first sidewall portion 812. The gas generator third sidewall portion 816 shares a gas generator second folding edge 826 with the gas generator second sidewall portion 814. The gas generator third sidewall portion 816 spaces the gas generator fourth sidewall portion 818 from the gas generator second sidewall portion 814. The gas generator fourth sidewall portion 818 shares a gas generator third folding edge 830 with the gas generator third sidewall portion 816.

Gas generator first tabs 840 extend from the gas generator first sidewall portion 812 at the first side 808 of the gas generator main portion 802. Gas generator first slots 844 are provided in the gas generator fourth sidewall portion 818 adjacent the second side 810 of the gas generator main portion 802. The gas generator first slots 844 correspond to gas generator first tabs 840.

A gas generator end wall portion 860 extends from the gas generator first sidewall portion 812 at the first end 804 of the gas generator main portion 802. The gas generator end wall portion 860 shares a gas generator fourth folding edge 862 with the gas generator first sidewall portion 812. The gas generator end wall portion 860 includes an integral mount for mounting a gas generator. In one example, the integral mount is an aperture 864 that is adapted to receive a gas generator. The gas generator end wall portion 864 includes a free edge 866 opposite the gas generator fourth folding edge 862. Gas generator second slots 868 are provided adjacent the free edge 866 of the gas generator end wall portion 860. Gas generator second tabs 870 extend from the gas generator third sidewall portion 816 at the first end 804 of the gas generator main portion 802. The gas generator second tabs 870 correspond to the gas generator second slots 868.

The rack housing part 700 includes a main portion 702 having opposing first and second ends 704, 706 and opposing first and second sides 708, 710. A rack housing first sidewall portion 712, a rack housing second sidewall portion 714, a rack housing third sidewall portion 716, and a rack housing fourth sidewall portion 718 extend between the first end 704 and the second end 706. The rack housing second sidewall portion 714 shares a rack housing first folding edge 722 with the rack housing first sidewall portion 712. The rack housing second sidewall portion 714 spaces the rack housing third sidewall portion 716 from the rack housing first sidewall portion 712. The rack housing third sidewall portion 716 shares a rack housing second folding edge 726 with the rack housing second sidewall portion 714. The rack housing third sidewall portion 716 spaces the rack housing fourth sidewall portion 718 from the rack housing second sidewall portion 714. The rack housing fourth sidewall portion 718 shares a rack housing third folding edge 730 with the rack housing third sidewall portion 716. The rack housing fourth sidewall portion 718 includes an aperture 790 that is adapted to receive a pinion.

A plurality of rack housing first tabs 740 extend from the rack housing first sidewall portion 712 at the first side 708 of the main portion 702. A plurality of rack housing first slots 744 are provided in the rack housing fourth sidewall portion 718 adjacent the second side 708 of the main portion 702. The plurality of rack housing first slots 744 correspond to the plurality of rack housing first tabs 740.

A rack housing end wall portion 780 extends from the rack housing third sidewall portion 716 at the second end 706 of the main portion 702. The rack housing end wall portion 780 shares a rack housing fourth folding edge 782 with the rack housing third sidewall portion 716. The rack housing end wall portion 780 includes a free edge 784 opposite the rack housing fourth folding edge 782. Rack housing second slots 786 are provided in the rack housing end wall portion 780 adjacent the free edge 784. Rack housing second tabs 788 extend from the rack housing first sidewall portion 712 at the second end 706 of the rack housing main portion 702. The rack housing second tabs 788 correspond to the rack housing second slots 786.

An example method of manufacturing the pretensioner housing 751 using the sheet metal blank 750 of FIG. 10 will now be described. First, the gas generator housing part 800 is folded along the gas generator first folding edge 822, the gas generator second folding 826 edge, and the gas generator third folding edge 830. This causes the gas generator first side wall portion 812, the gas generator second side wall portion 814, the gas generator third side wall portion 816, and the gas generator fourth side wall portion 818 to form an open ended tube and brings the gas generator first tabs 840 into engagement with the gas generator first slots 844. The gas generator first tabs 840 are then secured in the gas generator first slots 844 by, for example, staking and/or welding.

Next, the gas generator housing part 800 is folded along the fourth gas generator folding edge 862. This causes the gas generator end wall 860 to close one open end of the tube formed by the gas generator sidewall portions 812, 814, 816, 818 and brings the gas generator second tabs 870 into engagement with the gas generator second slots 868. The gas generator second tabs 870 are then secured in the gas generator second slots 868.

Next, the rack housing part 700 is folded along the rack housing first folding edge 722, the rack housing second folding edge 726, and the rack housing third folding edge 730. This causes the rack housing first side wall portion 712, the rack housing second side wall portion 714, the rack housing third side wall portion 716, and the rack housing fourth side wall portion 718 to form an open ended tube and brings the rack housing first tabs 740 into engagement with the rack housing first slots 744. The rack housing first tabs 740 are then secured in the rack housing first slots 744.

Next, the rack housing part 700 is folded along the rack housing fourth folding edge 782. This causes the rack end wall portion 780 to close one open end of the tube formed by the rack housing sidewall portions 712, 714, 716, 718 and brings the rack housing second tabs 788 into engagement with the rack housing second slots 786. The rack housing second tabs 788 are then secured in the rack housing second slots 786.

Finally, the remaining open end of the tube formed by the gas generator sidewall portions 812, 814, 816, 818 is secured to the remaining open end of the tube formed by the rack housing side wall portions 712, 714, 716, 718. Specifically, the second end 806 of the gas generator main portion 802 is secured to the first end 704 of the rack housing main portion 702 by, for example, welding, thereby completing the method of manufacturing the pretensioner housing 751. The completed pretensioner housing 751 can be attached to a retractor frame with the fourth sidewall portion 718 of the rack housing part 700 engaging one of the sidewalls of the retractor frame such that a pinion extends through the aperture 790 of the fourth sidewall portion 718.

The foregoing method is provided only as an example. It is contemplated that the order of the disclosed folding and securing steps can be rearranged. Furthermore, it is contemplated that portions of the completed pretensioner housing 751 can be welded so as to seal the pretensioner housing 751. Additionally, as would be appreciated by one of ordinary skill in the art, the rack can be inserted into the pretensioner housing 751 prior to any one of the steps described above, after the steps described above, or in-between the steps described above. Furthermore, as would be appreciated by one having ordinary skill in the art, the gas generator can be attached to the pretensioner housing 751 prior to any one of the steps described above, after the steps described above, or in-between the steps described above.

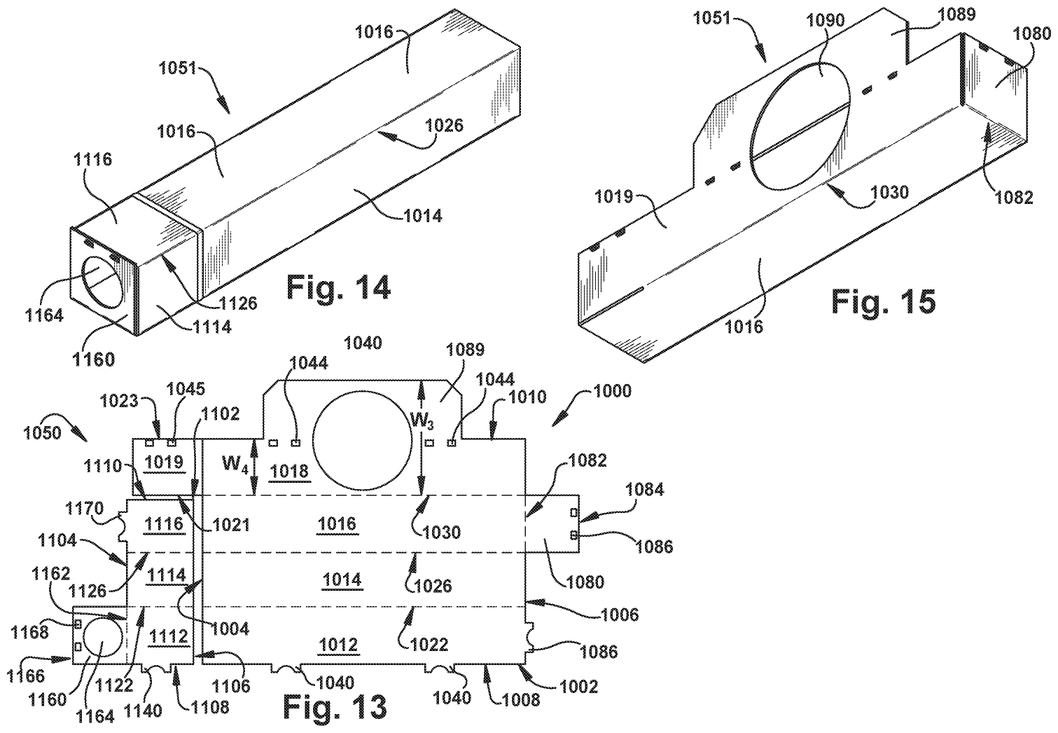

FIG. 13 shows another example of a sheet metal blank 1050 for forming a pretensioner housing 1051 (FIGS. 14 and 15). The sheet metal blank 1050 includes a rack housing part 1000 and a gas generator housing part 1100. The gas generator housing part 1100 includes a gas generator main portion 1102 having opposed first and second ends 1104, 1106 and opposing first and second sides 1108, 1110. A gas generator first sidewall portion 1112, a gas generator second sidewall portion 1114, and a gas generator third sidewall portion 1116 extend between the first end 1104 and the second end 1106. The gas generator second sidewall portion 1114 shares a gas generator first folding edge 1122 with the gas generator first sidewall portion 1112. The gas generator second sidewall portion 1114 spaces the gas generator third sidewall portion 1116 from the gas generator first sidewall portion 1112. The gas generator third sidewall portion 1116 shares a gas generator second folding edge 1126 with the gas generator second sidewall portion 1114. Gas generator first tabs 1140 extend from the gas generator first sidewall portion 1112 at the first side 1108 of the gas generator main portion 1102.

A gas generator end wall portion 1160 extends from the gas generator first sidewall portion 1112 at the first end 1104 of the gas generator main portion 1102. The gas generator end wall portion 1160 shares a gas generator fourth folding edge 1162 with the gas generator first sidewall portion 1112. The gas generator end wall portion 1160 includes an integral mount for mounting a gas generator. In one example, the integral mount is an aperture 1164 that is adapted to receive a gas generator. The gas generator end wall portion 1164 includes a free edge 1166 opposite the gas generator fourth folding edge 1162. Gas generator second slots 868 are provided in the gas generator end wall portion 1160 adjacent the free edge 1166. Gas generator second tabs 1170 extend from the gas generator third sidewall portion 1116 at the first end 1104 of the gas generator main portion 1102. The gas generator second tabs 1170 correspond to the gas generator second slots 1168.

The rack housing part 1000 includes a main portion 1002 having opposing first and second ends 1004, 1006 and opposing first and second sides 1008, 1010. A rack housing first sidewall portion 1012, a rack housing second sidewall portion 1014, a rack housing third sidewall portion 1016, and a rack housing fourth sidewall portion 1018 extend between the first end 1004 and the second end 1006. The rack housing second sidewall portion 1014 shares a rack housing first folding edge 1022 with the rack housing first sidewall portion 1012. The rack housing second sidewall portion 1014 spaces the rack housing third sidewall portion 1016 from the rack housing first sidewall portion 1012. The rack housing third sidewall portion 1016 shares a rack housing second folding edge 1026 with the rack housing second sidewall portion 1014. The rack housing third sidewall portion 1016 spaces the rack housing fourth sidewall portion 1018 from the rack housing second sidewall portion 1014. The rack housing fourth sidewall portion 1018 shares a rack housing third folding edge 1030 with the rack housing third sidewall portion 1016.

The rack housing fourth sidewall portion 1018 includes a retractor frame section 1089. The retractor frame section 1089 is adapted to form a sidewall of the retractor frame to which the pretensioner housing is attached. The retractor frame section 1089 has a width W₃ that is greater than a width W₄ of the remainder of the rack housing fourth sidewall portion 108. The retractor frame section 1089 includes an aperture 1090 for receiving a retractor spool.

Rack housing first slots 1044 are provided in the retractor frame section 1089 on opposite sides of the aperture 1090. A plurality of rack housing first tabs 1040 extend from the rack housing first sidewall portion 1012 at the first side 1008 of the main portion 1002. The plurality of rack housing first slots 1044 correspond to the plurality of rack housing first tabs 1040.

A gas generator extension 1019 extends from the rack housing fourth sidewall portion 1018 at the first end 1004 of the rack housing main portion 1002. The gas generator extension 1019 includes a first side 1021 that is aligned with the rack housing third folding edge 1030 and a second side 1023 that is aligned with an adjacent part of the second side 1010 of the main portion 1002. Gas generator extension slots 1045 are provided in the gas generator extension 1019 adjacent the second side 1023. The gas generator extension slots 1045 correspond to the second gas generator tabs 1140 that extend from the gas generator first sidewall portion 1112.

A rack housing end wall portion 1080 extends from the rack housing third sidewall portion 1016 at the second end 1006 of the main portion 1002. The rack housing end wall portion 1080 shares a rack housing fourth folding edge 1082 with the rack housing third sidewall portion 1016. The rack housing end wall portion 1080 includes a free edge 1084 opposite the rack housing fourth folding edge 1082. Rack housing second slots 1086 are provided in the rack housing end wall portion 1080 adjacent the free edge 1084. Rack housing second tabs 1088 extend from the rack housing first sidewall portion 1012 at the second end 1006 of the rack housing main portion 1002. The rack housing second tabs 1088 correspond to the rack housing second slots 1086.

An example method of manufacturing the pretensioner housing 1051 using the sheet metal blank 1050 of FIG. 13 will now be described. First, the gas generator housing part 1100 is folded along the gas generator first folding edge 1122 and the gas generator second folding edge 1126. This causes the gas generator first side wall portion 1112, the gas generator second side wall portion 1114 and the gas generator third side wall portion 1116 to form a U-shaped channel having open opposite ends.

Next, the gas generator housing part 1100 is folded along the gas generator third folding edge 1162. This causes the gas generator end wall 1160 to close one open end of the U-shaped channel formed by the gas generator sidewall portions 112, 114, 116 and brings the gas generator first tabs 1170 into engagement with the gas generator first slots 1168. The gas generator first tabs 1170 are then secured in the gas generator first slots 1168.

Next, the rack housing part 1000 is folded along the rack housing first folding edge 1022, the rack housing second folding edge 1026, and the rack housing third folding edge 1030. This causes the rack housing first side wall portion 1022, the rack housing second side wall portion 2014, the rack housing third side wall portion 1016, and the rack housing fourth side wall portion 1018 to form an open ended tube and brings the rack housing first tabs 1040 into engagement with the rack housing first slots 1044. The rack housing first tabs 1040 are then secured in the rack housing first slots 1044.

Next, the rack housing part 1000 is folded along the rack housing fourth folding edge 1082. This causes the rack end wall portion 1080 to close one open end of the tube formed by the rack housing sidewall portions 1012, 1014, 1016, 1018 and brings the rack housing second tabs 1088 into engagement with the rack housing second slots 1086. The rack housing second tabs 1088 are then secured in the rack housing second slots 1086.

The open end of the U-shaped channel formed by the gas generator sidewall portions 112, 114, 116 is then secured to the open end of the tube formed by the rack housing sidewall portions 1012, 1014, 1016, 1018. Specifically, the second end 1106 of the gas generator main portion 1102 is secured to the first end 1004 of the rack housing main portion 1002 and the second side 1110 of the gas generator main portion 1102 is secured to the first side 1021 of the gas generator extension 1019 by, for example, welding. This brings the gas generator second tabs 1140 into engagement with the gas generator extension slots 1045. The gas generator second tabs 1140 are then secured in the gas generator extension slots 1045, thereby completing the method of manufacturing the pretensioner housing 1051. The completed pretensioner housing 1051 is attached to the partial retractor frame to form the first sidewall.

The foregoing method is provided only as an example. It is contemplated that the order of the disclosed folding and securing steps can be rearranged. Additionally, as would be appreciated by one of ordinary skill in the art, the rack can be inserted into the pretensioner housing 1051 prior to any one of the steps described above, after the steps described above, or in-between the steps described above. Furthermore, as would be appreciated by one having ordinary skill in the art, the gas generator can be attached to the pretensioner housing 1051 prior to any one of the steps described above, after the steps described above, or in-between the steps described above.

What have been described above are examples of the disclosure. It is, of course, not possible to describe every conceivable combination of components or method for purposes of describing the disclosure, but one of ordinary skill in the art will recognize that many further combinations, permutations, and variations of the disclosure are possible. For example, the location of the aperture for the gas generator may be relocated to provide any desired orientation of the gas generator relative to the pretensioner housing. As another example, the location of the slots and/or the tabs can be changed. As yet another example, the sheet metal blank can be provided with as many sidewall portions as desired. Furthermore, it is contemplated that the disclosed pretensioner housing can be used with pretensioners other than the described rack and pinion pretensioner. Accordingly, the disclosure is intended to embrace all such alterations, modifications, and variations that fall within the scope of this application, including the appended claims.

1. A seatbelt system comprising:
a retractor frame;
a spool rotatably supported by the retractor frame;
webbing stored on the spool; and
a pretensioner, the pretensioner including a pretensioner housing attached to the retractor frame, the pretensioner housing being formed from a sheet metal blank having an integral mount for mounting a gas generator, the pretensioner housing having a plurality of walls that are separated by respective folding edges along which the sheet metal blank is folded to define an enclosed space.

2. The seatbelt system of claim 1, wherein the pretensioner includes a pinion that is connected for rotation with the spool, and wherein one wall of the plurality of walls includes an aperture through which the pinion extends into the enclosed space.

3. The seatbelt system of claim 2, wherein the pretensioner includes a rack received in the enclosed space, the rack being moveable relative to the pretensioner housing to cause rotation of the pinion.

4. The seatbelt system of claim 1, wherein the pretensioner includes a gas generator, and wherein the integral mount is an aperture provided on one wall of the plurality of walls, the aperture receiving the gas generator such that the gas generator is in fluid communication with the enclosed space.

5. The seatbelt system of claim 1, wherein the plurality of walls includes a first end wall, a second end wall, and a plurality of sidewalls that extend between the first end wall and the second end wall.

6. The seatbelt system of claim 5, wherein the plurality of sidewalls includes four sidewalls.

7. The seatbelt system of claim 5, wherein one of the plurality of sidewalls includes slots that are engaged by tabs provided on one other of the plurality of sidewalls.

8. The seatbelt system of claim 5, wherein at least one of the first end wall and the second end wall includes slots that are engaged by tabs provided on one of the plurality of sidewalls.

9. The seatbelt system of claim 5, wherein one wall of the plurality of sidewalls forms a part of the retractor frame.

10. The seatbelt system of claim 9, wherein the one wall of the plurality of walls that forms a part of the retractor frame includes an aperture that receives the spool.

11. The seatbelt system of claim 1, wherein the sheet metal blank is a single piece.

12. The seatbelt system of claim 1, wherein the sheet metal blank is multiple pieces.

13. The seatbelt system of claim 12, wherein a first piece of the multiple pieces includes the integral mount, the integral mount being a first aperture for receiving a gas generator and a second piece of the multiple pieces includes a second aperture for receiving at least one of the spool and a pinion that is connected for rotation with the spool.

14. A method of forming a pretensioner housing of a seatbelt system pretensioner, the method comprising the steps of:
forming an open ended tube by folding a sheet metal blank, the sheet metal blank having an integral mount for mounting a gas generator;
closing a first end of the tube with a first end wall portion by folding the sheet metal blank along a first folding edge; and
closing a second end of the tube with a second end wall portion by folding the sheet metal blank along a second folding edge.

15. The method of claim 14 further including engaging tabs on the main portion with slots on the main portion during the step of forming the open ended tube.

16. The method of claim 14, further including slots on one of the end wall portions and the main portion and tabs provided on one other of the end wall portions and the main portion, and engaging tabs on one of the end wall portions and the main portion with slots on one of the end wall portions and the main portion during the step of at least one of closing the first end of the tube and closing the second end of the tube.

17. The method of claim 14, wherein the step of forming the open ended tube includes forming an open ended tube having four sidewalls.

18. The method of claim 14, wherein the sheet metal blank has a first part and a second separate part, the method further including the step of securing the first part to the second part.

19. The method of claim 18, wherein the first part includes the integral mount, the integral mount being a first aperture for receiving a gas generator and the second part includes a second aperture for receiving at least one of a spool and a pinion that is connected for rotation with the spool.

20. The method of claim 19 wherein the second part forms a part of a retractor frame.
